(19) United States
(12) Patent Application Publication
(10) Pub. No.: US 2022/0400715 A1
(43) Pub. Date: Dec. 22, 2022

(54) LOW-DIGESTIBLE LEGUME STARCH

(71) Applicant: ROQUETTE FRERES, Lestrem (FR)

(72) Inventors: Julien PARCQ, Lille (FR); Alban DUPONT, Calonne Sur La Lys (FR); Marie ALBERT, Marcq En Baroeul (FR); Fabrice DESAILLY, Avion (FR)

(21) Appl. No.: 17/756,295

(22) PCT Filed: Nov. 19, 2020
(86) PCT No.: PCT/FR2020/052135

§ 371 Date: May 20, 2022

Related U.S. Application Data
(60) Provisional application No. 62/976,531, filed on Feb. 14, 2020.

(30) Foreign Application Priority Data
Nov. 22, 2019 (FR) FR1913094

(51) Int. Cl. A23L 11/00; A23L 29/212

(52) U.S. Cl. CPC A23L 11/05; A23L 29/212; A23V 2002/00

(57) ABSTRACT

The invention relates to legume starches having a slowly digestible starch (SDS) content of 30 to 34% by weight, characterized in that they also have a very slowly digestible starch (vSDS) content of 34 to 40% by weight.

The present invention relates to legume starches, in particular pea starches, with a slowly digestible starch (SDS) content of between 30 and 34% by weight, further characterized by a very slowly digestible starch (vSDS) content of between 34 and 40% by weight (a standard deviation of 2% is tolerated on these values given inter-experimental variability).

The present invention also relates to the use of this controlled content of slowly (SDS) and very slowly (vSDS) digestible starches in order to select batches of pea starches with a total content of slowly and very slowly digestible starch greater than 60% by weight and to ensure controlled homogeneity of the product.

### FIELD OF THE INVENTION

From a physiological point of view, in humans or animals, the main part of the carbohydrates ingested during the diet is represented by starch, an energy reserve molecule characteristic of plants and the main component of starchy foods (pasta, flour, potatoes).

During digestion, the starch molecules break down into linear glucan chains, which are then broken down into simple glucoses, which can be assimilated by the digestive system.

The digestion of starch begins in the mouth during chewing thanks to an enzyme in saliva: salivary amylase.

This first decomposition of the starch is stopped by the acidity of the stomach but resumes in the duodenum (first part of the small intestine) thanks to the action of pancreatic and intestinal amylases.

The successive action of all these amylases leads to the appearance of a disaccharide known as maltose, which will be itself transformed into two simple sugars, which are glucoses.

Synthesized biochemically, a source of carbohydrates, starch is one of the most widespread organic materials in the plant kingdom, where it constitutes organisms' nutrient reserves.

It is thus naturally present in the reserve organs and tissues of higher plants, in particular in cereal grains (wheat, corn, etc.), legume grains (peas, beans, etc.), potato or cassava tubers, roots, bulbs, stems and fruit.

Starch is a mixture of two homopolymers, amylose and amylopectin, composed of D-glucose units bonded to one another via α-(1-4) and α-(1-6) linkages which are the source of branching in the structure of the molecule.

These two homopolymers differ in terms of the degree of branching thereof, and the degree of polymerization thereof.

Amylose is slightly branched with short branches and has the molecular weight of between 10,000 and 1,000,000 Dalton. The molecule is formed of 600 to 1,000 glucose molecules.

Amylopectin is a branched molecule with long branches every 24 to 30 glucose units via α (1-6) linkages. The molecular weight thereof ranges from 1,000,000 to 100,000,000 Dalton, and the degree of branching thereof is approximately 5%. The total chain may include between 10,000 and 100,000 glucose units.

The ratio of amylose to amylopectin depends on the botanical source of the starch.

Starch is stored in reserve organs and tissues in a granular state, i.e. in the form of semi-crystalline granules.

This semi-crystalline state is essentially due to the amylopectin macromolecules.

In the native state, starch grains have a degree of crystallinity which ranges from 15 to 45% by weight, which depends substantially on the botanical origin and on the method performed for their extraction.

Granular starch placed under polarized light thus has, in microscopy, a characteristic black cross referred to as “Maltese cross”.

This phenomenon of positive birefringence is due to the semi-crystalline organization of these granules: the average orientation of the polymer chains is radial.

For a more detailed description of granular starch, reference may be made to chapter II, entitled “Structure et morphologie du grain d'amidon” [“Structure and morphology of the starch grain”] by S. Perez, in the work “Initiation à la chimie et à la physico-chimie macromolëculaires” [“Introduction to macromolecule chemistry and physical chemistry”], first edition, 2000, volume 13, pages 41 to 86, Groupe Français d'Etudes et d'Applications des Polymères [French Polymer Group].

Dry starch contains water content which ranges from 12 to 20% by weight, depending on the botanical origin. This water content obviously depends on the residual moisture of the medium (for aw=1, the starch may fix up to 0.5 g of water per gram of starch).

Heating, with an excess of water, a starch suspension to temperatures of greater than 50° C. leads to irreversible swelling of the grains and leads to the dispersion thereof, then the dissolution thereof.

It is these properties in particular which give starch its technological properties of interest.

For a given temperature range, referred to as “gelatinization range”, the starch grain will very quickly swell and lose its semi-crystalline structure (loss of birefringence).

All the grains will be as swollen as possible over a temperature range of approximately 5 to 10° C. A paste is obtained which consists of swollen grains that constitute the dispersed phase, and of molecules (mainly amylose) that thicken the aqueous continuous phase.

The rheological properties of the paste depend on the relative proportion of these two phases and on the swelling volume of the grains. The gelatinization range is variable depending on the botanical origin of the starch.

The maximum viscosity is obtained when the starch paste contains a large number of highly swollen grains. When heating is continued, the grains will burst and the material will disperse into the medium, however dissolution will only occur for temperatures of greater than 100° C.

Amylose-lipid complexes have delayed swelling because the combination prevents the interaction of the amylose with the water molecules, and temperatures of greater than 90° C. are necessary in order to obtain the total swelling of the grains (because the amylomaize is complexed to the lipids).

The disappearance of the grains and the dissolution of the macromolecules leads to a reduction in the viscosity.

Lowering the temperature (by cooling) of the starch paste causes insolubilization of the macromolecules and phase separation due to the incompatibility between amylose and amylopectin, then crystallization of these macromolecules is observed.

This phenomenon is known by the name retrogradation.

When a paste contains amylose, it is this first molecule which will undergo retrogradation.

It will consist in the formation of a double helix and the combination of these double helices to form “crystals” (type B) which will give rise to a three-dimensional network via junction zones.

This network is formed very quickly, in a few hours. During the development of this network, the association of the double helices with one another via hydrogen bonds displaces the water molecules associated with the helices and causes significant syneresis.

The structural complexity of starch and its physical/chemical properties mean that this class of carbohydrates is assimilated and digested in different ways by humans and animals.

This is why starch can be classified into three categories, according to its digestibility: rapidly digestible, slowly digestible, or not digestible.

Starch, which is naturally granular/semi-crystalline, can be converted to rapidly digestible starch (RDS) after exposure to heat, pressure and/or moisture during food processes.

Slowly digestible starch (SDS) takes longer to be broken down by digestive enzymes than RDS because it has a still-crystalline structure and is less accessible to digestive enzymes.

The digestion of this SDS fraction leads to a moderate and regular release of glucose into the blood. These are known as low G.I. starches (for “low glycemic index”).

Foods with high SDS content will then elicit lower postprandial glycemic responses and lower insulin responses than foods with only low SDS content.

Conversely, RDS are nutritious carbohydrates, as they release their glucose into the bloodstream much more quickly.

As for the so-called resistant starches (RS), they can be treated as non-digestible fibers (such as corn bran, oat fibers, gums) by the intestinal enzymes.

It is accepted in the state of the art that total starch is the sum of its three components RDS, SDS and RS.

These different starch fractions are therefore digested at different rates in the human digestive system.

It is therefore accepted that SDS have a slower digestion rate than RDS. RS are a fraction of the starch that resists enzymatic digestion in the small intestine. They will be fermented in the large intestine and can therefore be considered dietary fiber.

The SDS and RDS fractions are therefore the sources of available glucose.

SDS are naturally present in some uncooked grains, cereals such as wheat, rice, barley, rye, corn, in legumes such as peas, beans and lentils.

The SDS content is mainly influenced by the gelatinization of the starch during food processing.

Indeed, during this process, exposure to temperature, pressure and humidity leads to the conversion of the SDS fraction to RDS, making the starch more accessible to enzymatic digestion.

This conversion can be minimized by controlling the cooking conditions to limit starch gelatinization.

Therefore, the original SDS content in the food composition or product will depend on the way its preparation has been conducted.

For example, it is known that food products that contain a lot of SDS are some pasta, parboiled rice, pearl barley and some cookies, as opposed to puffed breakfast cereals or bread, which usually contain very little.

The SDS content of foods is classically determined using an in vitro method developed by H. N. ENGLYST and colleagues (published in 1992 in the European Journal of Clinical Nutrition, volume 46, pp S33-S50).

In the following, reference will be made to this 1992 method “according to ENGLYST”.

This method was developed to simulate the enzymatic digestion that occurs in the small intestine.

A sample of product or starch is introduced into a tube, in the presence of digestive enzymes, and the release of glucose is measured during 120 minutes of reaction.

This method tells apart:
The RDS fraction, by measuring rapidly available glucose (RAG); in this case, measuring the glucose released between 0 and 20 minutes;
The SDS fraction, by measuring slowly available glucose (SAG); in this case, measuring the glucose released between 20 and 120 minutes;
The RS fraction, which corresponds to the glucose not released after 120 minutes, which is calculated, according to the ENGLYST method, by the following formula: TS−(RDS+SDS) where TS=total starch (considered equal to 100% by weight when analyses are performed on starch as such).

Carbohydrate-rich foods containing more than 50% by weight of available carbohydrates from starch, of which at least 40% by weight is SDS, are traditionally considered high-SDS foods.

They are therefore recommended to limit the glycemic index and the production of insulin, compared to foods lower in SDS.

Of all the starches traditionally used in these food applications, legume starches and more particularly pea starch, is a candidate of choice.

Indeed, pea seeds are known for their high starch content (between 55 and 70% by of weight dry matter) and for their low glycemic index (Ratnayake et al., 2002, Pea starch, composition, structure and properties—A review, in Starch/Stärke, 54, 217-234).

Native pea starches, with an SDS content classically between 27 and 38% by weight according to ENGLYST, are therefore of interest for nutritional applications.

However, variability between batches of pea starch does not always satisfy the expressed needs. This variability is due to two major criteria: seasonality (variable inter-season quality of the pea starches produced) and the various extraction methods used (impact of the hydro-thermal treatments used during the processes).

In order to guarantee the quality of the pea starch batches, the Applicant company found that it was possible to obtain this result by determining and defining particular contents of SDS and of a fraction not previously characterized by the ENGLYST method, the so-called “very slowly digestible starch” or vSDS fraction.

### DETAILED DESCRIPTION

Thus, the invention relates to legume starches, in particular pea starches, with a slowly digestible starch (SDS) content of between 30 and 34% by weight, further characterized in that they have a very slowly digestible starch (vSDS) content of between 34 and 40% by weight, with a standard deviation of 2% tolerated, with respect to the inter-experimental variability.

The present invention also relates to the use of this controlled content of slowly (SDS) and very slowly (vSDS) digestible starches in order to select batches of pea starches with a total content of slowly and very slowly digestible starch greater than 64% by weight and to ensure controlled homogeneity of the product.

For the purposes of the present invention, “legume” means any plant belonging to the families of the cesalpiniaceae, mimosaceae or papilionaceae, and particularly any plant belonging to the family of the papilionaceae, for example pea, bean, broad bean, field bean, lentil, alfalfa, clover or lupin. The article by R. HOOVER et al. entitled “Composition, structure, functionality and chemical modification of legume starches: a review”, published in Can. J. Physiol. Pharmacol. 1991, 69 pp. 79-92) describes various legumes in its tables.

Preferably, the legume is selected from the group comprising pea, bean, broad bean and field bean.

Advantageously, it is pea, the term “pea” being considered here in its broadest sense and including in particular:
all the wild-type varieties of “smooth pea”, and
all mutant varieties of “smooth pea” and “wrinkled pea”, regardless of the uses for which said varieties are usually intended (human food, animal feed and/or other uses).

Said mutant varieties are in particular those named “mutants r”, “mutants rb”, “mutants rug 3”, “mutants rug 4”, “mutants rug 5” and “mutants lam” as described in the article by C-L HEYDLEY et al., entitled “Developing novel pea starches.” Proceedings of the Symposium of the Industrial Biochemistry and Biotechnology Group of the Biochemical Society, 1996, pp. 77-87.

According to another advantageous variant, legumes (for example varieties of pea or field bean) are plants giving grains containing at least 25%, preferably at least 40%, by weight of starch (dry/dry).

“Legume starch” is intended to mean any composition extracted, by any means, from a legume and in particular from a papilionaceae, the starch content of which is greater than 40%, preferably greater than 50% and even more preferentially greater than 75%, these percentages being expressed as dry weight relative to the dry weight of said composition.

Advantageously, this starch content is greater than 90% by weight (dry/dry). It may in particular be greater than 95% by weight, including greater than 98% by weight.

“Native” starch means a starch which has not undergone any chemical modification.

In order to determine their basic SDS fraction content, pea starches whether according to the invention or not are analyzed following the in vitro digestion operating conditions of the method of H. N. Englyst et al in “Classification and measurement of nutritionally important starch fractions”, Eur. J. Clin. Nutr., 46 (Supp. 2), S33-S50 (1992).

The method consists of measuring the rapidly digestible (RDS), slowly digestible (SDS) and non-digestible (resistant) starch fractions (RS) contained in a food.

These fractions are determined after enzymatic digestion with pancreatin, amyloglucosidase and invertase.

The released glucose is measured by colorimetry, using a glucose oxidase kit Glucose GOD FS referenced 1 2500 99 10 923, marketed by the company DiaSys Distribution France Sari, following the protocol of said kit.

The details of the method implemented for measuring digestion according to ENGLYST are as follows.

### Reagents Used:

Anhydrous sodium acetate (ref: 71184, from SIGMA)
Benzoic acid (ref: 242381, from SIGMA)
CaCl2) (ref: 1.02378.0500, from MERCK)
Acetic acid 0.1M (ref: 33209, from SIGMA)
Pork pancreatin 8×USP (ref: P 7545, from SIGMA)
Amyloglucosidase EC 3.2.1.3 (from SIGMA, with activity ≥260 U/mL/≈300 AGU/mL, Cat. NO. A7095)
Invertase EC 3.2.1.26 (from SIMA, with activity ≥300 units/mg solid, Cat. NO. I-4504)
Guar (ref: G4129, from SIGMA)
Ethanol at 66°

### Procedure

Preparing the Saturated Benzoic Acid Solution

Weigh 4 g of benzoic acid in 1 L of RO water and mix. The solution can be stored at room temperature for 1 month.

Preparing 1 M/L CaCl2) Solution.

Weigh 1.1098 g of CaCl2) in 10 mL of RO water and mix. The solution can be stored at room temperature for 1 month.

Preparing Acetate Buffer at 0.1 M-pH 5.2.

Weigh 8.203 g of anhydrous sodium acetate in 250 mL of saturated benzoic acid solution,
Add 500 mL of RO water and mix,
Adjust the pH to 5.2+/−0.5 with 0.1 M acetic acid,
Complete with 1000 mL of RO water in a volumetric flask,
Add 4 mL of the 1 M CaCl2) solution to 1 L of prepared buffer,
Mix and check the pH.
   The solution can be stored at 4° C. for 1 month.

Preparing Guar Gum Solution in Acetate Buffer
Weigh precisely 750 mg of Guar gum in 300 mL of acetate buffer
Put under continuous agitation

Preparing the Samples to be Analyzed and the Enzymes Used

Preparing the Samples
Weigh precisely 0.8 g of dry starch to be tested,
Add 20 mL of 0.1 M acetate buffer solution—pH 5.2+Guar gum,
Place the vials in a water bath for 15 minutes under agitation at 37° C.,
Take 0.1 mL of the solution obtained at T=0 minute then add 0.9 mL of ethanol at 66° (i.e. a 1/10^{th} dilution),
Determine glucose (as a %) by colorimetry at time T=0 min.
   A blank and a standard (weighing 0.5 g of anhydrous dextrose) are made under the same conditions as the sample preparation.

Preparing the Enzymatic Cocktail

The enzymatic cocktail is designed to test 12 samples. It should be prepared the same day according to the following protocols.

Preparing Pig Pancreatin 8×USP.

Prepare 4 solutions of pancreatin to obtain 54 mL of supernatant.

To do this:
Weigh 2.5 g of pig pancreatin 8×USP,
Add 20 mL of RO water and mix for 10 minutes,
Centrifuge the solution at 1500 G for 10 minutes,
Collect 13.5 mL of supernatant.

Preparing Amyloglucosidase
Dilute 3.7 mL of amyloglucosidase EC 3.2.1.3 solution with 4.3 mL of RO water and mix for 10 minutes,
Take 6 mL of the new solution and add it to the 54 mL of pancreatic supernatant and mix.

Preparing Invertase

Weigh 50 mg of invertase EC 3.2.1.26,
Add 6 mL of RO water and mix for 10 minutes,
Take 4 mL of the new solution and add it to the 54 mL of pancreatic supernatant and mix.

### Digestion Protocol

Add 5 mL of enzymatic cocktail to the sample preparations
Incubate for 120 minutes at 37° C. in a thermostatic bath with agitation,
Take 0.1 mL of the solution obtained at T=20 minutes and at T=120 minutes then add 0.9 mL of ethanol at 66° (i.e. a 1/10^{th} dilution),
Mix and centrifuge the samples at 1500 G for 3 minutes,
Determine glucose (as a %) by colorimetry at times T=20 min and T=120 min.

Determination of Free Glucose (Fg) and Total Glucose (Tg) Levels

The free glucose (FG) level corresponds to the measurement taken at time 0 min.

The total glucose (TG) level is measured as follows:
Take 0.25 mL of the solution obtained at T=120 min in an “Eppendorf” type tube,
   Add 0.25 mL of 4 N hydrochloric acid, mix,
Place the tube, dry, in a water bath at 100° C. for 45 minutes, let cool to room temperature,
Neutralize the hydrolyzed solution with 0.25 mL of 4 N sodium hydroxide,
Add 0.25 mL of RO water, mix
Make a 1/10^{th} dilution in RO water (0.1 mL in 0.9 mL). That is to say a final dilution to 1/40^{th}.

Determining RDS, SDS and RS

Determining the glucose released at times:
T=0 min (initial glucose content),
T=20 min (glucose content released after 20 minutes)
T=120 min (glucose content released after 120 minutes).

According to the ENGLYST method:

$$Glucose ( \% ) = \frac{At \times Vt \times C \times D}{As \times Wt} \times 100$$

Where
At=Absorbance (sample)−Absorbance (blank)
Vt=Total volume (sample in mL)
C=Concentration of the standard (glucose in mg/mL)
D=Dilution factor
As=Absorbance (standard−Absorbance (blank)
Wt=Dry weight (sample in mg)

The determination of the RDS, SDS and RS fractions is performed as follows:

RDS=(G20−FG)×0.9

SDS=(G120−G20)×0.9

RS=TS−(RDS+SDS) where TS=(TG−FG)×0.9

According to this method, native pea starch classically has an RDS content of between 13 and 16% by weight, an SDS content of between 27 and 38% by weight, and an RS content of between 45 and 56% by weight, these values being expressed with a standard deviation of 2% in light of inter-experimental variability.

The applicant recommends first selecting pea starch batches with an SDS content between 30 and 34% by weight, which are more likely to meet the required digestibility criteria, and then determining the content of the very slowly digestible starch (vSDS).

After many long investigations, the applicant company found that contrary to what was established by ENGLYST, the so-called digestion-resistant (RS) fraction was digested, provided that the reaction kinetics were not stopped at 120 minutes.

To its knowledge, only CHUNG et al, 2009, in Carbohydrates Polymer, vol 75, pp 436-447, has proposed classifying pea starches based on slightly different hydrolysis conditions from ENGLYST, i.e. the SDS fraction being the one digested between 20 and 180 minutes.

This modification results in an increase in the content of “slowly digestible” starches, but calculated on the basis of an SDS fraction that no longer corresponds to the formula initially described by Englyst, which limits the reaction kinetics to 120 minutes.

The Applicant company extended the ENGLYST digestion kinetics to 500 minutes, and observed that legume starches, particularly pea starches, continued to be digested beyond the 120-minute point, reaching a plateau of maximum digestibility at the 420-minute point.

The Applicant has therefore chosen to take advantage of this new, even more slowly digestible starch to define the “very slowly digestible” or vSDS component in accordance with the invention.

Furthermore, and this is one of the keys to this extended conducting of the ENGLYST test as commonly accepted in the state of the art, this vSDS rate corresponds to the digestion of a sub-fraction of the RS content of leguminous starch, notably pea, as initially defined by ENGLYST beyond 120 minutes. The RDS and SDS content, meanwhile, remains unchanged.

Therefore, contrary to what is known in the state of the art, in particular by CHUNG et al. mentioned above, the present invention does not involve changing the operating conditions of the ENGLYST test to artificially increase the SDS level, but rather to adopt operating conditions that allow the real glucose release capacity of the leguminous starches, in particular of the pea considered, to be determined by extending the ENGLYST digestion to its end, defined here by the plateau reached at time 420 minutes.

The invention therefore further relates to a method for determining the vSDS fraction content of a legume starch, this content being determined by measuring the glucose release by extending the ENGLYST digestion to its end, defined by the plateau reached at time 420 minutes. Finally, the invention further relates to the use of the measurement of the content of the very slowly digestible starch of a legume starch to obtain a starch according to the invention.

The measurement of glucose release carried out at time 420 minutes allows the development of a new formula that makes it possible:

1) to correct the RS fraction value (called “corrected RS” in this case), based on the observation that maximum digestibility is reached at the plateau after 420 minutes of digestion.
It is then deduced that the corrected RS (non-digestible fraction after 420 minutes) is equal to 100−(T420×0.9). The correction factor 0.9 being necessary for the calculation of fractions according to the ENGLSYT method.
2) To deduce the vSDS content by simple calculation:

vSDS=100−(RDS+SDS+corrected RS).

The invention will be better understood on reading the following examples, which are intended to be illustrative, only mentioning certain embodiments and certain advantageous properties according to the invention, and are non-limiting.

### EXAMPLES

### Example 1: 1 Batch of Native Pea Starch Produced by the Applicant

company under the trade name N735 (referenced as batch WS88V) was analyzed according to ENGLYST (1992) up to 120 minutes and then up to 420 minutes of reaction time.

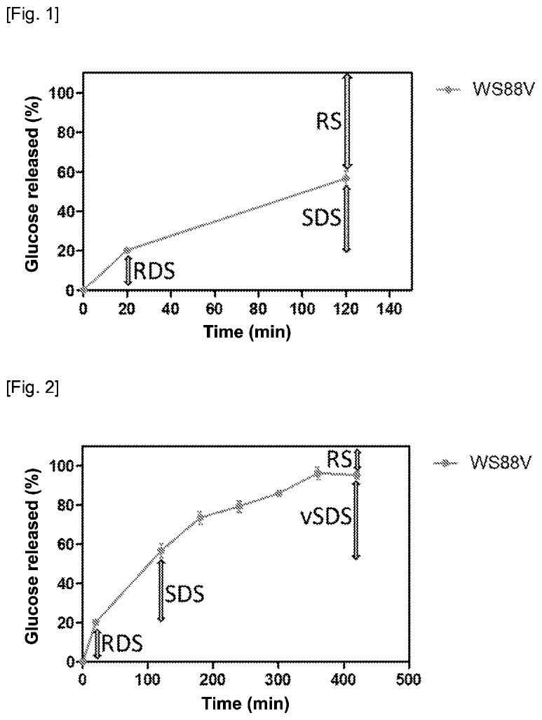

FIG. 1 shows the kinetics according to ENGLYST up to 120 minutes.

FIG. 2 repeats the data from FIG. 1 and extends the kinetics to 420 minutes.

The following Table 1 gives the contents in weight percent of RDS, SDS and RS calculated by the traditional ENGLYST method.

TABLE 1

| | RDS | SDS | |
|---|---|---|---|
| | (between 0 and | (between 20 and | RS |
| | 20 minutes) | 120 minutes) | (by calculation) |
| WS88V | 18 | 33 | 49 |

Extending the digestion kinetics to 420 minutes, and performing the measurement of glucose released after 420 minutes, the content by weight percent of corrected RS and vSDS recorded in the following Table 2 are obtained by calculation.

TABLE 2

| | RDS | SDS | | |
|---|---|---|---|---|
| | (between 0 and | (between 20 and | RS | vSDS |
| | 20 minutes) | 120 minutes) | (corrected) | (by calculation) |
| WS50V | 18 | 33 | 12 | 37 |

### Example 2: Extensive Characterization and Selection of Digestion Profiles of Different Pea Starch Batches

Extended digestion kinetics were performed on 14 additional batches of native pea starch extracted by the Applicant company, which not only confirm the inter-batch variability in digestibility, but also define the most suitable batches for the targeted applications. The following Table 3 gives the content in weight percent of RDS, SDS, RS and vSDS.

TABLE 3

| | | SDS = | Corrected | vSDS = |
|---|---|---|---|---|
| Native | RDS = | (GT120 min − | RS = | 100 − |
| pea starch | (GT20 min − | GT20 min) × | 100 − | (RDS + SDS + |
| batches | GT0) × 0.9 | 0.9 | (T420 × 0.9) | corrected RS) |
| WL81V | 15.8 | 35.5 | 9.4 | 39.2 |
| WS66V | 15.5 | 33.3 | 12.6 | 38.6 |
| WP01V | 13.8 | 33.5 | 14.4 | 38.3 |
| WU62V | 16.5 | 29.8 | 19.0 | 34.7 |
| W9034 | 15.7 | 30.3 | 20.5 | 33.5 |
| WW25V | 17.5 | 29.9 | 18.2 | 34.3 |
| W9061 | 14.5 | 32.6 | 20.2 | 32.6 |
| W9125 | 17.1 | 30.7 | 12.8 | 39.4 |
| W9159 | 15.1 | 30.9 | 18.9 | 35.1 |
| W9167 | 17.9 | 34.4 | 19.8 | 27.9 |
| WX24V | 18.4 | 27.6 | 18.3 | 35.7 |
| W9237 | 17.1 | 29.4 | 13.7 | 39.8 |
| W9258 | 17.4 | 31.4 | 13.7 | 37.5 |
| WX72V | 17.4 | 31.4 | 13.7 | 37.5 |

It follows that if we define our pea starches by an SDS content between 30 and 34% by weight and a vSDS content between 34 and 40% by weight (standard deviation 2%), we must exclude the batches WX24V (SDS too low) and W9167 (SDS content acceptable, but vSDS content too low). This selection method ensures that only pea starch batches with a controlled homogeneity and a total content of slowly and very slowly digestible starch greater than 64% by weight are offered.

1-5. (canceled)

6. A legume starch with a content of slowly digestible starch (SDS) comprised between 30 and 34% by weight, wherein it also has a content of very slowly digestible starch (vSDS), comprised between 34 and 40% by weight.

7. The starch according to claim 6, wherein the legume starch is selected from the group of pea, bean, broad bean, field bean, lentil, alfalfa, clover and lupin starches, and is particularly pea starch.

8. The starch according to claim 6, wherein it has a total slowly and very slowly digestible starch content of more than 64% by weight.

9. A method for determining the vSDS content of a legume starch, this content being determined by measuring the glucose release by extending the ENGLYST digestion to its end, defined by the plateau reached at time 420 minutes.

10. Use of a method for determining the vSDS content of a legume starch, this content being determined by measuring the glucose release by extending the ENGLYST digestion to its end, defined by the plateau reached at time 420 minutes, to obtain a starch according to claim 6.
